(19) United States
(12) Patent Application Publication
(10) Pub. No.: US 2026/0170714 A1
(43) Pub. Date: Jun. 18, 2026

(54) Learning Grainy Texture Parameters in the Frequency Domain

(71) Applicant: Advanced Micro Devices, Inc., Santa Clara, CA (US)

(72) Inventor: Li Chen, Shanghai (CN)

(73) Assignee: Advanced Micro Devices, Inc., Santa Clara, CA (US)

(21) Appl. No.: 18/984,639

(22) Filed: Dec. 17, 2024

(51) Int. Cl. G06T 11/00; G06T 7/40; G06T 11/60; G06V 10/60

(52) U.S. Cl. CPC G06T 11/10; G06T 7/40; G06T 11/60; G06V 10/60

(57) ABSTRACT

Learning grainy texture parameters in the frequency domain is described. A training image dataset with images depicting a desired grainy texture is received. Using the flat regions extracted from images of the training dataset, a target spectrum is computed, which represents the power spectral density in the extracted flat regions. Gain values for different grain bases are then generated based on the target spectrum. From the gain values for the different grain bases, band power and brightness power values are derived, which allows for separate control over the frequency content and luminance dependency of the graininess in an image. The band power and brightness power values are used to generate grainy texture parameters. The grainy texture parameters are used to generate an image having a desired grainy texture.

### BACKGROUND

Digital image processing often involves meticulous parameter tuning to produce images having a desired appearance (e.g., desired texture, lighting, color fidelity, etc.), such as when translating raw image sensor data into high-quality images. This process typically requires extensive experimentation with various parameters (e.g., exposure, white balance, contrast, sharpness, noise reduction, etc.) to enhance realism of image data, while preserving details captured by the image sensor. As such, the parameter tuning process involved in generating images that depict a desired texture is time-consuming, frequently extending over several weeks. Each tweak involves capturing and analyzing sample images, assessing output quality, and refining parameters until the desired outcome aligns with a desired result (e.g., a desired texture as observed by human observers).

### BRIEF DESCRIPTION OF THE DRAWINGS

FIG. 1 is a block diagram of a processing system configured to implement a grainy texture system and an image processing system in accordance with the described techniques.

FIG. 2 is a block diagram of an example system showing the grainy texture system of FIG. 1 as generating grainy texture parameters for use by the image processing system of FIG. 1.

FIG. 3 is a block diagram of an example system showing the image processing system of FIG. 1 as generating a grainy texture image using the grainy texture parameters generated by the grainy texture system of FIG. 1.

FIG. 4 depicts a procedure in an example implementation of generating grainy texture parameters learned from a training image dataset in accordance with the techniques described herein.

FIG. 5 depicts a procedure in an example implementation of updating image data by modifying a texture property of the image data using grainy texture parameters generated in accordance with the techniques described herein.

### DETAILED DESCRIPTION

In the spatial domain, an image is typically represented as a two-dimensional grid of pixels, where each pixel value corresponds to an intensity level in grayscale images, or a combination of red, green, and blue values in color images. This pixel-based representation describes how light intensity is distributed across the image. Conversely, in the frequency domain, an image is represented in terms of its spatial frequency components, which describe how pixel intensities change across the image.

To transform an image from the spatial domain to the frequency domain, a transformation (e.g., a two-dimensional Discrete Fourier Transform) is applied to image data. The transformation decomposes the image into a sum of sinusoidal functions with varying frequencies. In this transformation, low-frequency components correspond to slow or gradual variations in intensity, such as smooth gradients, while high-frequency components represent rapid changes, such as edges, fine textures, and sharp details.

In transforming an image from a spatial domain to a frequency domain, the process begins with a two-dimensional matrix of pixel values, representing the image in the spatial domain. When the transformation is applied, the image is broken down into its constituent frequency components, which are represented as a complex-valued matrix. Each element in this matrix corresponds to a specific frequency and contains two pieces of information: amplitude and phase. The amplitude indicates how much of a corresponding frequency is present in the image, while the phase indicates the position or orientation of that frequency in relation to the rest of the image.

This frequency domain representation has practical applications in image processing. For example, filtering in the frequency domain allows selective manipulation of certain image features. A low-pass filter can be applied to remove high-frequency components, which results in the suppression of fine details and produces a blurred image. Conversely, a high-pass filter removes low-frequency components, enhancing fine details such as edges. Such filtering operations are more efficient in the frequency domain than in the spatial domain, as they operate directly on the frequency components rather than on pixel values.

Another important application is image compression. Techniques such as JPEG compression transform the image into the frequency domain using a related method known as the Discrete Cosine Transform (DCT). In the frequency domain, the image is represented more compactly by discarding higher frequency components that are less perceptible to the human eye, thus reducing the amount of data needed to represent the image without significant loss of visual quality.

In the frequency domain, a grainy texture in an image is characterized by the presence of high-frequency components. Grainy texture typically refers to rapid fluctuations in intensity that occur across an image, often visualized as noise, rough surfaces, and so forth. These rapid changes in pixel intensity correspond to high spatial frequencies, which are represented in the outer regions of the frequency domain after transforming image data from the spatial domain. When an image contains grainy texture, the frequency domain representation will exhibit specific spectrum characteristics, which are closely related to a grain size of the grainy texture. Generally, energy will concentrate in low frequencies for grainy texture with larger grain size, whereas the energy will concentrate in high frequencies for grainy texture with smaller grain size. This, the grain size of a grainy texture provides a visual cue regarding spectral characteristics of the grainy texture, as exhibited in a frequency domain representation of an image.

Significantly, grainy texture is often random, such that that the corresponding high-frequency components in the frequency domain may not have an easily discernible structure. Unlike regular patterns, such as stripes or grids, which result in distinct, predictable peaks in the frequency domain, grainy textures result in a more diffuse or scattered distribution of high-frequency components. This randomness is typical of noise-like textures, where no particular orientation or periodicity dominates, and is not a structure that can be readily identified or described with an acceptable degree of precisions by a human observer.

In the context of an image capture device, such as a camera, several parameters influence how high-frequency components, including grainy texture, are represented in the captured image. These parameters influencing grainy texture (e.g., grainy texture parameters) include ISO sensitivity as defined by the International Organization for Standardization, shutter speed, aperture, sensor size, resolution, in-camera noise reduction settings, and so forth. By adjusting these parameters, photographers can control the amount of noise and fine detail in their images. For instance, lowering ISO, using a wider aperture, or utilizing a larger sensor can reduce grainy texture, while higher ISO, small sensors, and high resolution may increase its visibility. In each implementation, a critical trade-off often lies between preserving fine detail and minimizing noise, particularly in challenging lighting conditions. Due to subjective preferences and requirements, the same underlying image data requires different parameter settings to produce different visual effects or styles, as each parameter adjustment shapes the final image in unique ways to meet specific aesthetic goals.

Using conventional image processing techniques, tuning each of these parameters (e.g., hundreds of parameters) involves testing multiple settings for each parameter to achieve an optimal balance, which often requires significant iterations to identify how parameter setting adjustments affect the final image's quality. For example, tuning noise reduction impacts detail clarity, while modifying color balance impacts overall image tone, and so forth, such that adjustments to one parameter frequently necessitate tweaks to one or more other parameters before achieving a desired image appearance.

As such, tuning image processing parameters using conventional techniques is time-consuming and requires extensive user inputs, frequently extending over several weeks. For instance, using conventional techniques, a single parameter setting tweak involves capturing and analyzing sample images, assessing output quality, and refining parameters for target image data until the desired appearance aligns with the desired image appearance. This iterative, manually intensive approach is crucial for modifying image sensor data to achieve a desired image appearance, as even slight parameter variations yield markedly different results. Consequently, conventional image processing techniques are labor-intensive and time-consuming, involving both qualitative visual assessments and quantitative measurements to produce desired image quality for a specific application.

To address these conventional shortcomings facing conventional image processing techniques, learning grainy texture parameters in the frequency domain is described. In implementations, a grainy texture system receives a training image dataset that includes a plurality of training images depicting a desired grainy texture (e.g., as depicted in images under different lighting conditions, in different scenes, with different objects, different backgrounds, and so forth). In some implementations, the training image dataset includes images captured by a single image capture device, such that parameters describing grainy texture as captured by the single image capture device are learned in the frequency domain.

To do so, the grainy texture system extracts flat regions by cropping regions of interest from an original image. As described herein, a “flat region” in an image refers to a portion of the image that does not include one or more edges. Generally, in flat regions, pixel values are similar with each other and varying smoothly over relatively large area. Thus, flat regions of an image contrast with edge regions of an image, such that a portion of an image including one or more strong edges will not be identified as a flat region.

As a specific example, individual swatches of a ColorChecker chart are used as training samples to identify flat regions, where borders separating individual swatches from one another correspond to edges. In a ColorChecker chart, an array of swatches includes scientifically prepared natural, chromatic, primary and grayscale-colored squares in a wide range of colors. Many of the squares represent natural objects, such as human skin, foliage, blue sky, and so forth. Individual swatches exemplify the color of their counterparts and reflect light the same way in all parts of the visible spectrum, such that a swatch matches the colors of representative sample natural objects under any illumination, and with any color reproduction process.

Using the extracted flat regions, the grainy texture system generates a target spectrum that represents the power spectral density of frequency components in the extracted flat regions. The grainy texture system then generates gain values for different grain bases (e.g., coarse, medium, fine, etc.) that best match the target spectrum. From the gain values for the different grain bases, band power and brightness power values are derived, which allows for separate control over the frequency content and luminance dependency of the graininess in an image, enabling more precise texture manipulation. The band power and brightness power values are used to generate grainy texture parameters, which, when applied to image data, enable generation of a grainy texture image having grainy texture that appears visually similar to grainy texture as depicted by the plurality of training images in the training image dataset. The grainy texture parameters are useable by an image processing system to generate the grainy texture image.

The described techniques for learning grainy texture parameters in the frequency domain, and generating images based on the learned grainy texture parameters, represent an improvement over conventional image processing techniques by significantly reducing the time required for the parameter tuning process (e.g., from weeks to seconds, minutes, or hours). Consequently, a processing system tasked with generating an image having a desired grainy texture is improved by significantly reducing the processing time and computing resources required to generate the image having the desired grainy texture.

In some aspects, the techniques described herein relate to an apparatus including a processor to generate grainy texture parameters based on grainy texture depicted in images of a training image dataset and memory to store a grainy texture image generated by modifying image data using the grainy texture parameters.

In some aspects, the techniques described herein relate to an apparatus, wherein the processor is configured to generate the grainy texture parameters by analyzing the grainy texture depicted in the images of the training image dataset in a frequency domain.

In some aspects, the techniques described herein relate to an apparatus, wherein the processor is configured to generate the grainy texture parameters by extracting at least one flat region from each of the images included in the training image dataset.

In some aspects, the techniques described herein relate to an apparatus, wherein the processor is configured to generate the grainy texture parameters by estimating a target spectrum, based on the at least one flat region.

In some aspects, the techniques described herein relate to an apparatus, wherein the processor is configured to generate the grainy texture parameters by generating grain bases gain values based on the target spectrum.

In some aspects, the techniques described herein relate to an apparatus, wherein the grain bases gain values include gain values for a plurality of different grain bases, wherein the plurality of different grain bases include at least a coarse grain, a medium grain, and a fine grain.

In some aspects, the techniques described herein relate to an apparatus, wherein the processor is further configured to generate the grain bases gain values based on basis cross-spectra that represent a comparison of frequency domain characteristics of two grainy texture bases.

In some aspects, the techniques described herein relate to an apparatus, wherein the processor is configured to generate the grainy texture parameters by deriving at least one band power value from the grain bases gain values.

In some aspects, the techniques described herein relate to an apparatus, wherein the processor is configured to generate the grainy texture parameters by deriving at least one brightness power value from the grain bases gain values.

In some aspects, the techniques described herein relate to an apparatus, wherein the processor is further configured to generate the grainy texture image by modifying at least one non-texture parameter of the image data.

In some aspects, the techniques described herein relate to an apparatus, further including a display configured to output a visual representation of the grainy texture image.

In some aspects, the techniques described herein relate to a system including connection circuitry configured to receive a training image dataset including a plurality of images and grainy texture circuitry configured to extract one or more flat regions from each of the plurality of images included in the training image dataset, estimate a target spectrum based on the one or more flat regions, generate gain values for at least two grain bases based on the target spectrum, generate at least one band power value based on the gain values for the at least two grain bases, generate at least one brightness power value based on the gain values for the at least two grain bases, and output grainy texture parameters that include the at least one band power value and the at least one brightness power value.

In some aspects, the techniques described herein relate to a system, wherein the grainy texture circuitry is further configured to generate gain values for the at least two grain bases based on basis cross-spectra that represent a comparison of frequency domain characteristics of two grainy texture bases.

In some aspects, the techniques described herein relate to a system, wherein the at least two grain bases include at least a coarse grain, a medium grain, and a fine grain.

In some aspects, the techniques described herein relate to a system, further including image processing circuitry configured to generate a grainy texture image by modifying image data using the grainy texture parameters.

In some aspects, the techniques described herein relate to a system, wherein the grainy texture circuitry is configured to extract the one or more flat regions from each of the plurality of images included in the training image dataset before transforming each of the plurality of images included in the training image dataset from a spatial domain to a frequency domain.

In some aspects, the techniques described herein relate to a method implemented by at least one processing device, the method including receiving a training image dataset that includes a plurality of training images, generating grainy texture parameters that represent, in a frequency domain, grainy texture as depicted in the plurality of training images of the training image dataset, generating a grainy texture image by modifying image data using the grainy texture parameters, and displaying the grainy texture image.

In some aspects, the techniques described herein relate to a method, wherein generating the grainy texture parameters includes extracting at least one flat region from each of the plurality of training images of the training image dataset, estimating a target spectrum based on the at least one flat region, generating grain bases gain values based on the target spectrum, deriving at least one band power value from the grain bases gain values, and deriving at least one brightness power value from the grain bases gain values.

In some aspects, the techniques described herein relate to a method, wherein the grain bases gain values include gain values for a plurality of different grain bases, wherein the plurality of different grain bases include at least a coarse grain, a medium grain, and a fine grain.

In some aspects, the techniques described herein relate to a method, further including generating the grainy texture image by modifying at least one non-texture parameter of the image data independent of the grainy texture parameters.

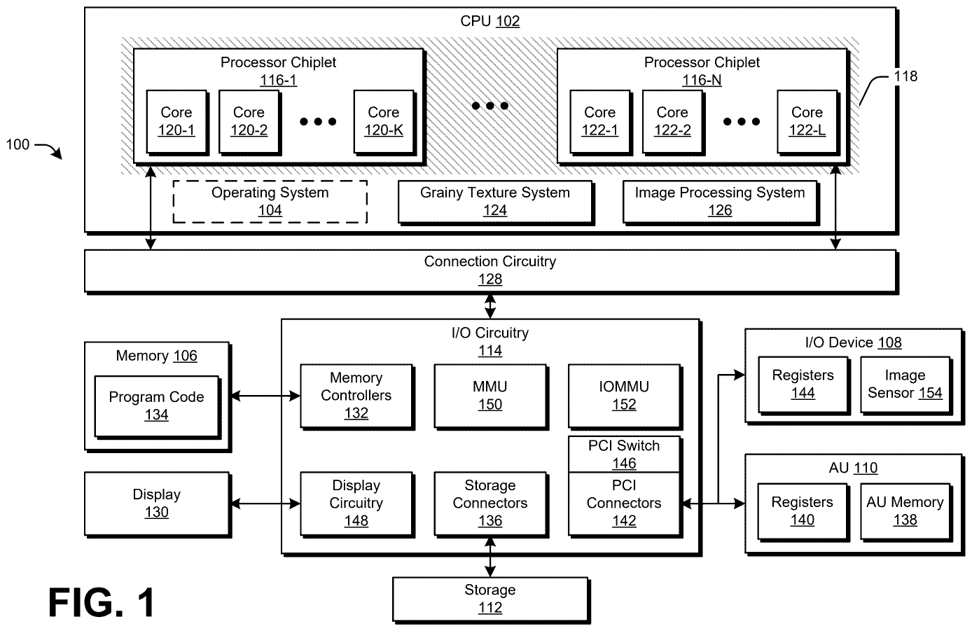

FIG. 1 is a block diagram of a processing system configured to execute one or more applications, in accordance with one or more implementations.

FIG. 1 includes a processing system 100 configured to execute one or more applications, such as computing applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a camera, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, to allocate portions of resources (e.g., system memory 106, CPU 102, input/output (I/O) device 108, accelerator unit (AU) 110, storage 112, I/O circuitry 114) for the execution of tasks for the applications, to provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116 of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations, each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both. In the illustrated example of FIG. 1, K, L, and N each represent integers greater than or equal to one.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

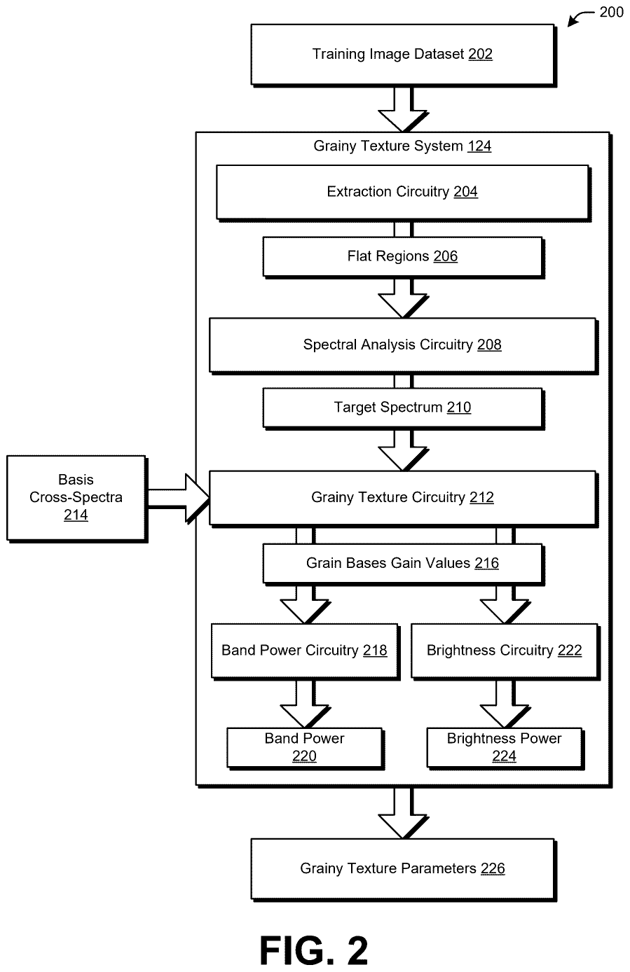

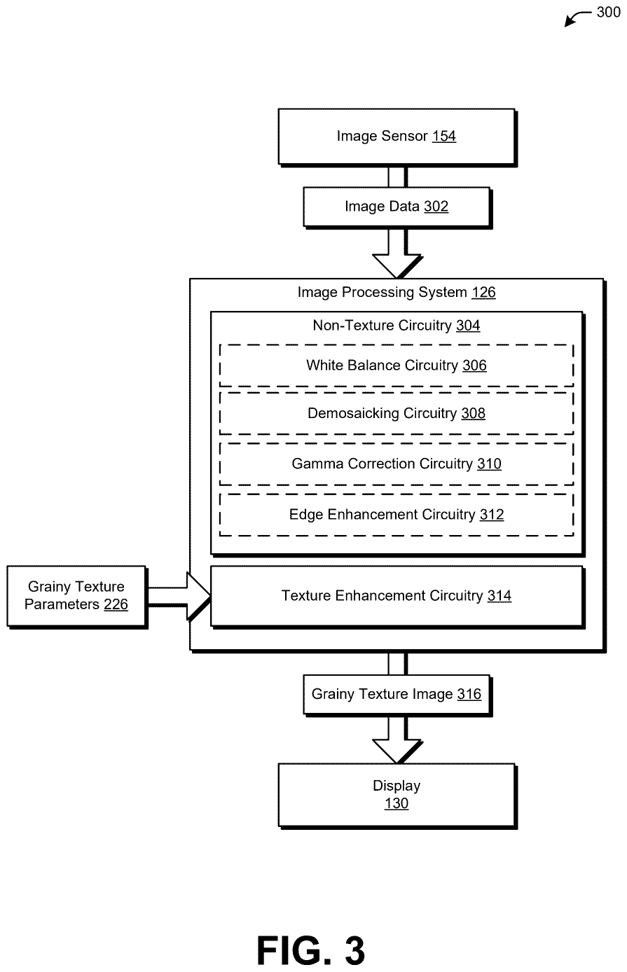

In the illustrated example of FIG. 1, the CPU 102 is depicted as including a grainy texture system 124 and an image processing system 126. The grainy texture system 124 represents functionality of the processing system 100 to learn grainy texture parameters in a frequency domain from images of a training dataset, as described in further detail below with respect to FIG. 2. The image processing system 126 represents functionality of the processing system 100 to generate a grainy texture image by applying grainy texture parameters output by the grainy texture system 124 to image data (e.g., image data captured by image sensor 154), as described in further detail below with respect to FIG. 3. In some implementations, the image processing system 126 is further configured to output the grainy texture image generated using grainy texture parameters produced by the grainy texture system 124, such as by visually rendering the grainy texture image via the display 130.

In the illustrated example of FIG. 1, the grainy texture system 124 and the image processing system 126 are depicted in the CPU 102 of the processing system 100. In one or more implementations, however, the grainy texture system 124 and/or the image processing system 126 included in and/or is implemented by one or more different components of the processing system 100, such as the CPU 102, the memory 106, the I/O device 108, the AU 110, the storage 112, the I/O circuitry 114, and so forth. In at least one implementation, at least one of the grainy texture system 124 or the image processing system 126, or portions of the at least one of the grainy texture system 124 or the image processing system 126 are included in at least two of the depicted components of the processing system 100. Alternatively or additionally, in some implementations the grainy texture system 124 and the image processing system 126 are implemented in separate instances of the processing system 100. By way of example, the grainy texture system 124 is included in a first instance of the processing system 100 (e.g., a first device) and the image processing system 126 is included in a second instance of the processing system 100 (e.g., a second device). As a specific example, the image processing system 126 is implemented in an instance of the processing system 100 configured as an image capture device (e.g., a camera), and the grainy texture system 124 is implemented in a separate instance of the processing system 100 (e.g., a computing device tasked with generating grainy texture parameters to be used by the image capture device in processing image data captured by an image sensor). Thus, as described in further detail below, the described techniques enabled via the grainy texture system 124 and the image processing system 126 are configured for implementation across a range of different hardware configurations.

Additionally, within the processing system 100, the CPU 102 is communicatively coupled to an I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. Thus, the memory controllers 132 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 134 (e.g., an executable file) associated with the application from, for example, a storage 112 into system memory 106. This storage 112, for example, includes a non-volatile storage such as a flash memory, solid-state memory, hard disk, optical disc, or the like configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCI connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In accordance with the described techniques, the I/O device 108 is representative of an image capture device that includes at least one image sensor 154 configured to capture image data (e.g., still images, video, combinations thereof, and so forth). For instance, the image sensor 154 is representative of a charge-coupled device (CCD), a complementary metal-oxide-semiconductor (CMOS) sensor, or any other type of image sensor in accordance with the described techniques. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort (DP) connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 150 and input-output memory management unit (IOMMU) 152. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

FIG. 2 is a block diagram of an example system 200 showing the grainy texture system 124 as generating grainy texture parameters for use by the image processing system 126.

In the illustrated example of FIG. 2, the grainy texture system 124 is depicted as receiving a training image dataset 202. The training image dataset 202 is representative of a plurality of different training images, where each training image represents a unique instance of visual data captured by one or more image capture devices. The training images are captured by image sensors of the one or more image capture devices under a variety of conditions that influence a visual appearance of the respective training image, including diverse lighting conditions, such as natural light, artificial light, low-light, high-contrast scenarios, and so forth.

In implementations, the training image dataset 202 includes a collection of training images that depict different scenes, capture a range of backgrounds, objects, and environments, which introduce variation in composition, texture, and context (e.g., relative to different images in the training image dataset 202). In implementations, training images of the training image dataset 202 are captured using different exposure settings and other image capture device-specific parameters. By representing a range of different image data capture conditions and settings, the training image dataset 202 is representative of a diverse dataset, depicting how image capture parameters affect the appearance of objects, surfaces, backgrounds, environments, and other visual elements perceived in an image generated from captured image data.

The grainy texture system 124 is trained to learn, from the training image dataset 202 and in the frequency domain, grainy texture parameters that, when applied to image data, result in an image having grainy texture similar to grainy texture depicted in the training image dataset 202. Thus, in one implementation, the training image dataset 202 represents a plurality of training images captured by a camera and the grainy texture parameters learned from the training image dataset 202 represent parameters for grainy texture that closely match a grainy texture in an image captured by the camera.

In implementations, grainy texture parameters are represented as a mixture of m grain bases, N₁, N₂, . . . , Nₘ, which are generated by convolving a Gaussian white noise signal Ng with m band-pass filters F₁, F₂, . . . , Fₘ. In implementations, the Gaussian white noise signal is generated by applying a hard-coded lookup table, or Box-Muller transform, to uniform random variables. In such implementations, the band-pass filters implemented by the grainy texture system 124 are designed to produce different frequency responses, which correspond to different grain sizes. In these implementations, grainy texture is obtained by multiplying the weighted sum of the grain bases with a brightness-dependent power to compensate visual discrepancy associated with different brightnesses. As such, a grainy texture can be expressed as a mixture of m grain bases, as set forth in Equation 1:

$$N = {\sum }_{i = 1}^{m} {w}_{i} {N}_{i} , {N}_{i} = {F}_{i} ⊗ {N}_{g} , i = 1 , 2 , … , m , \qquad ( Eq . 1 )$$

where ⊗ represents the convolution operator.

As a specific example, fine, medium, and coarse grains are generated by convolving the Gaussian white noise signal with the following three filters F₁, F₂, and F₃:

$${F}_{1} = \frac{1}{16} [ \begin{matrix}- 1 & 2 & - 1 \\ - 2 & - 12 & - 2 \\ - 1 & 2 & - 1\end{matrix} ] ,$$

$${F}_{2} = \frac{1}{64} [ \begin{matrix}1 & - 2 & - 2 & - 2 & 1 \\ - 2 & 0 & 4 & 0 & - 2 \\ - 2 & 4 & 12 & 4 & - 2 \\ - 2 & 0 & 4 & 0 & - 2 \\ 1 & - 2 & - 2 & - 2 & 1\end{matrix} ] ,$$

$${F}_{3} = \frac{1}{64} [ \begin{matrix}1 & 2 & 2 & 2 & 1 \\ 2 & 4 & 4 & 4 & 2 \\ 2 & 4 & 4 & 4 & 2 \\ 2 & 4 & 4 & 4 & 2 \\ 1 & 2 & 2 & 2 & 1\end{matrix} ] .$$

To learn grainy texture parameters from the training image dataset 202 in the frequency domain, the grainy texture system 124 includes extraction circuitry 204. The extraction circuitry 204 is configured to extract one or more flat regions 206 from individual training images included in the training image dataset 202.

In implementations, the extraction circuitry 204 is configured to extract flat regions 206 prior to transforming the image (e.g., using the Fourier Transform) to generate a resulting frequency spectrum. In the resulting frequency spectrum, low-frequency components are concentrated around a center, while high-frequency components are spread out towards edges.

The extraction circuitry 204 crops flat regions 206 from an image and provides the isolated flat regions 206 to the spectral analysis circuitry 208. Using the flat regions 206, the spectral analysis circuitry 208 estimates a target spectrum 210 of a benchmark target (e.g., a power spectral density of a benchmark target that is referenced during learning grainy texture parameters) from the training image dataset 202.

As described herein, the target spectrum 210 is generated using the frequency domain representations of the flat regions 206, by calculating the power spectral density of frequency components in the flat regions 206, representing the power distribution across different frequencies. The target spectrum 210 is generated by averaging the power spectral densities of multiple ones of the flat regions 206. In this manner, the target spectrum 210 encapsulates the typical frequency characteristics of grainy texture areas, serving as a useful benchmark for grainy texture analysis.

The target spectrum 210 is then provided to grainy texture circuitry 212. The grainy texture circuitry 212 processes the target spectrum 210 and basis cross-spectra 214 to generate grain bases gain values 216. The grain bases gain values 216 represents total gain values for different grain bases (e.g., coarse grain, medium grain, fine grain, etc.) that best match the target spectrum 210, and thus represent gain values for the different grainy textures as depicted in the training image dataset 202.

In implementations, the grainy texture circuitry 212 generates the grain bases gain values 216 using an optimization algorithm as set forth in Equation 2:

$${w}^{*} = {arg min}_{w} {‖ Q ∘ ( S ( w ) - {S}_{t} ) ‖}_{2}^{2} \qquad ( Eq . 2 )$$

In Equation 2, Sₜ represents the target spectrum 210, w=[w₁, . . . wₘ]^{T} represents the vector of total gains, S(w) is the spectrum of the produced grainy texture, and Q is a spectral weighting matrix to balance the frequency domain.

In Equation 2, “o” denotes an element-wise product operation.

As a specific example, in some implementations the spectral weighting matrix implemented by the grainy texture circuitry 212 is:

$$Q = \frac{1}{\vert {S}_{t} \vert + ϵ} ,$$

where ϵ=10⁻⁹ is used to avoid division by zero. In another implementation, the spectral weighting matrix is implemented using the quadratic form:

$$Q = \frac{1}{{S}_{t}^{2} + ϵ} .$$

Consequently, the produced grainy texture S(w) has the following quadratic form: S(w)=w^{T} [symbol] w, where [symbol] represents the basis cross-spectra 214. A single basis cross-spectrum of the basis cross-spectra 214 is a measure that quantifies a relationship between two signals in the frequency domain. A basis cross-spectrum thus describes how different signals interact with each other at various frequencies. In implementations, a given basis cross-spectrum may represent two different signals or two identical signals. The basis cross-spectra 214 thus represents a comparison of frequency domain characteristics of two grainy texture bases (e.g., coarse vs. fine). Specifically, the basis cross-spectra 214 can be expressed as:

$$𝕊 = [ \begin{matrix}{S}_{11} & … & {S}_{1 m} \\ ⋮ & ⋱ & ⋮ \\ {S}_{m 1} & … & {S}_{m m}\end{matrix} ] , {S}_{ij} = Re ( \overline{ℱ ( {N}_{i} )} ∘ ℱ ( {N}_{j} ) ) , i , j = 1 , 2 , … , m .$$

In the above expression of the basis cross-spectra, [symbol] denotes the two-dimensional Fourier transform and Re denotes the real part. In some implementations, the basis cross-spectra 214 are computed in advance (e.g., by a developer of the grainy texture system 124, a user of the grainy texture system 124, combinations thereof, and so forth). As an example, in some implementations the Welch's method is used to estimate spectra to reduce overall variance of the spectral estimation involved in generating the grain bases gain values 216. For instance, the overall frame for an image is partitioned into K×K overlapping blocks of size M×M. Within each block, a sample of cross-spectra is computed as set forth in Equation 3:

$$\begin{matrix}{S}_{i j}^{( k l )} ≅ \frac{1}{{‖ W ‖}_{2}^{2}} Re ( \overline{ℱ ( W ∘ {N}_{i}^{( k l )} )} ∘ ℱ ( W ∘ {N}_{j}^{( k l )} ) ) , \\ i , j = 1 , 2 , … , M , k , l = 1 , 2 , … , K\end{matrix} . \qquad ( Eq . 3 )$$

In Equation 3, W denotes the two-dimensional window function used to reduce spectral leakage. As a non-limiting example, in some implementations the two-dimensional window function uses the following Hamming window:

$$W = {[ ( 1 - cos ( 2 π p / M ) ) \cdot ( 1 - cos ( 2 π q / M ) ) ]}_{p , q = 0}^{M - 1} .$$

The final cross-spectra Sᵢⱼ are calculated by averaging Equation 3 over K×K blocks, as represented by Equation 4:

$${S}_{i j} ≅ \frac{1}{{K}^{2}} {\sum }_{k = 1}^{K} {\sum }_{l = 1}^{K} {S}_{i j}^{( k l )} , i , j = 1 , 2 , … , m . \qquad ( Eq . 4 )$$

In a similar manner, in some implementations the target spectrum 210 generated by the spectral analysis circuitry 208 is estimated using Welch's method, expressed according to Equation 5:

$${S}_{t} ≅ \frac{1}{{K}^{2}} {\sum }_{k = 1}^{K} {\sum }_{l = 1}^{K} {S}_{t}^{( k l )} , {S}_{t}^{( k l )} ≅ \frac{1}{{‖ W ‖}_{2}^{2}} {\vert ℱ ( W ∘ {N}_{t}^{( k l )} ) \vert}^{2} , \qquad ( Eq . 5 )$$

where Nₜ represents a patch from a target image.

In some implementations, the grainy texture system 124 interpolates the target spectrum 210 to match a resolution of grain basis as defined by the basis cross-spectra 214.

Because Equation 2 is non-convex and admits no close-form solution, the grainy texture circuitry 212 is configured to iteratively minimize the objective function with respect to one variable while fixing other variables. Specifically, the grainy texture circuitry 212 generates the grain bases gain values 216 by iteratively solving the following sub-problems expressed in Equation 6 and Equation 7.

$${v}_{k} = {arg min}_{v} {‖ Q ∘ ( {u}_{k}^{⊤} 𝕊 v - {S}_{t} ) ‖}_{2}^{2} , \qquad ( Eq . 6 )$$

$${u}_{k + 1} = {arg min}_{u} {‖ Q ∘ ( {u}^{⊤} 𝕊 {v}_{k} - {S}_{t} ) ‖}_{2}^{2} . \qquad ( Eq . 7 )$$

In solving the sub-problem expressed in Equation 6, the grainy texture circuitry 212 fixes u and minimizes over v. In solving the sub-problem expressed in Equation 7, the grainy texture circuitry 212 fixes v and minimizes over u. The resulting sequence uₖ or vₖ will converge to the optimal solution w* of Equation 2. In some implementations, the grainy texture circuitry 212 solves the sub-problems of Equations 6 and 7 using the least-squares method.

Stated differently, the grainy texture circuitry 212 generates the grain bases gain values 216 according to the following algorithm, as defined by steps 1-13:

```
  1. Initialize k = 0 and u₀ = [1, ··· , 1]^{T}
  2. while k < Kₘₐₓ do
      3. Xₖ = Q ∘ ( [symbol] uₖ)
      $4. {v}_{k} = {( {X}_{k}^{T} {X}_{k} )}^{- 1} {X}_{k}^{T} ( Q ∘ {S}_{t} )$
      5. Yₖ = Q ∘ ( [symbol] vₖ)
      $6. {u}_{k + 1} = {( {Y}_{k}^{T} {Y}_{k} )}^{- 1} {Y}_{k}^{T} ( Q ∘ {S}_{t} )$
      $7. if \frac{{‖ {u}_{k + 1} - {u}_{k} ‖}_{2}}{{‖ {u}_{k} ‖}_{2}} < η then$
            8. break
      9. else
          10. k = k + 1
    11. end if
12. end while
13. w^{*} = u_{k*}
```

In step 2, Kₘₐₓ represents a maximum number of iterations to be performed, which is configurable as any suitable integer. In some implementations, a value of Kₘₐₓ is pre-defined by the grainy texture system 124. Alternatively or additionally, a value of Kₘₐₓ is defined by a user of the grainy texture system 124. In step 7, η represents a tolerance value, which is configurable as any suitable value. In some implementations, a value of η is pre-defined by the grainy texture system 124. Alternatively or additionally, a value of η is defined by a user of the grainy texture system 124. Thus, the respective values of η and Kₘₐₓ are configurable based on accuracy requirements associated with implementing the grainy texture system 124.

Thus, the grain bases gain values 216 represent amplitudes or coefficients assigned to specific frequency components (e.g., basis functions) that model grainy texture depicted in an image. When an image is transformed from the spatial domain to the frequency domain using mathematical tools like the Fourier Transform, it is represented as a sum of sinusoidal functions of varying frequencies and orientations. These sinusoidal functions are called basis functions because they form the foundational components from which the image can be reconstructed, with each basis function corresponding to a specific frequency and direction.

As noted above, because grainy textures are characterized by rapid intensity variations over small spatial regions, which correspond to high-frequency components in the frequency domain. The collection of basis functions that represent these frequency components is sometimes referred to as the “grain basis.” Gain values are the amplitudes or scaling factors applied to each basis function, determining how much each frequency component contributes to the overall image appearance. By modifying the gain values of the grain basis the image processing system 126 controls the intensity and appearance of an image's grainy texture (e.g., increasing gain values enhances grainy texture).

The grain bases gain values 216 are output by the grainy texture circuitry 212 to band power circuitry 218, which is configured to decompose the grain bases gain values 216 into band power 220. Similarly, the grain bases gain values 216 are output to brightness circuitry 222, which is configured to decompose the grain bases gain values 216 into brightness power 224. Decomposing the grain bases gain values 216 into band power 220 and brightness power 224 allows for separate control over the frequency content and luminance dependency of the graininess in an image, enabling more precise texture manipulation.

As described herein, band power 220 represents the amount of energy or power allocated to specific frequency bands within an image's frequency spectrum. The band power 220 thus quantifies how much grainy texture is emphasized or suppressed across different spatial frequencies. By adjusting the band power 220, the image processing system 126 can control the scale and intensity of grainy texture, making grainy texture of an image appear finer or coarser. For example, increasing the band power 220 in high-frequency bands amplifies rapid intensity variations, enhancing grainy texture, while decreasing the band power 220 reduces these variations, softening the grainy texture.

Conversely, the brightness power 224 modulates grainy texture based on luminance levels of an image. The brightness power 224 defines how the amplitude of the grainy texture components varies with the brightness of different regions. Thus, the brightness power 224 allows the grainy texture to interact naturally with the image's brightness, making grain more or less pronounced in brighter or darker areas. For instance, a higher brightness power 224 in darker regions can make graininess more noticeable where it is aesthetically desired, while reducing brightness power 224 in brighter areas can prevent oversaturation of grainy texture.

Respective values of the band power 220 and the brightness power 224 are combined into grainy texture parameters 226, which are useable by the image processing system 126 to generate a grainy texture image having a similar grainy texture as represented by the training image dataset 202, described in further detail below. By decomposing grain basis gain values 216 into band power 220 and brightness power 224 parameters, derived from target images of the training image dataset 202, the grainy texture system 124 learns grainy texture parameters 226 in the frequency domain. The grainy texture parameters 226 are useable by the image processing system 126 to independently adjust the frequency characteristics of an image's grainy texture, while also considering integration of the grainy texture with luminance variations. This separation of band power 220 and brightness power 224 parameters facilitates sophisticated control over the grainy texture, allowing for tailored enhancements or reductions that align with both the spatial frequency content and the brightness levels within image data.

FIG. 3 is a block diagram of an example system 300 showing the image processing system 126 as generating a grainy texture image using the grainy texture parameters generated by the grainy texture system 124.

In the illustrated example of FIG. 3, the image processing system 126 is depicted as receiving image data 302 captured by the image sensor 154. The image processing system 126 represents functionality of the processing system 100 to perform image signal processing on raw image data (e.g., image data 302 as captured by the image sensor 154) to enhance image quality. In implementations, the image signal processing pipeline of operations performed by the image processing system 126 can be broadly categorized as non-texture enhancement operations and texture enhancement operations.

In the illustrated example of FIG. 3, the image processing system 126 includes non-texture circuitry 304, which represents functionality of the image processing system 126 to perform non-texture enhancement operations on the image data 302. In the illustrated example of FIG. 3, the non-texture circuitry 304 includes white balance circuitry 306, demosaicking circuitry 308, gamma correction circuitry 310, and edge enhancement circuitry 312.

The white balance circuitry 306 performs white balance adjustments on the raw image data 302 to correct color casts resulting from different lighting conditions during image capture. The white balance circuitry 306 calibrates the intensities of the red, green, and blue channels so that neutral colors (whites and grays) appear natural, ensuring accurate color reproduction across the entire image.

Next, the demosaicking circuitry 308 reconstructs a full-color image from the incomplete color samples provided by a color filter array of the image sensor 154 (such as a Bayer filter). For instance, the demosaicking circuitry 308 extracts raw information captured by the image sensor 154 (e.g., data collected by light sensors configured to detect red, blue, and green colors). Because each pixel in the raw image data 302 captures only one color component, demosaicking algorithms interpolate the missing color information by analyzing neighboring pixels, resulting in a complete RGB image for each pixel location.

The gamma correction circuitry 310 adjusts the luminance of the image to compensate for the non-linear response of display systems and human vision. By applying a gamma curve, this gamma correction circuitry 310 modifies the brightness levels in image data 302 to enhance visual perception, ensuring that details in shadows and highlights are preserved and that the overall contrast of the image is optimized for display.

The edge enhancement circuitry 312 enhances the sharpness and definition of the image data 302 by emphasizing transitions in intensity between adjacent pixels. The edge enhancement circuitry 312 applies edge detection and sharpening filters to accentuate fine details and contours within the image, improving clarity without significantly increasing noise or introducing artifacts.

The non-texture circuitry 304 represents functionality of the image processing system 126 to modify at least one non-texture parameter of the image data 302 independent of (e.g., without) the grainy texture parameters 226. In implementations, inclusion of the non-texture circuitry 304, or sub-circuitry thereof, in the image processing system 126 is optional. For instance, in some implementations the image processing system 126 includes only texture enhancement circuitry 314, such that non-texture enhancement operations on the image data 302 are not performed by the image processing system 126. Alternatively, the image processing system 126 includes fewer or additional aspects of the non-texture circuitry 304 to perform non-texture enhancement operations on the image data 302. For instance, in some implementations the non-texture circuitry 304 includes noise reduction circuitry that minimizes unwanted signals (e.g., “noise”) that results from processing the image data 302 by sub-circuitry of the non-texture circuitry 304 (e.g., the non-texture circuitry 304 performs noise reduction on an output of the demosaicking circuitry 308 before it is processed by the gamma correction circuitry 310).

In the illustrated example of FIG. 3, the image processing system 126 includes texture enhancement circuitry 314, which represents functionality of the processing system 100 to generate a grainy texture image 316 by applying the grainy texture parameters 226 to the image data 302. In implementations, generating the grainy texture image 316 involves adjusting a visual appearance of the image data 302 using one or more of the band power 220 or the brightness power 224, as derived from the grain bases gain values 216 and set forth in the grainy texture parameters 226. The grainy texture image 316 is then output for display, such as for rendering via the display 130.

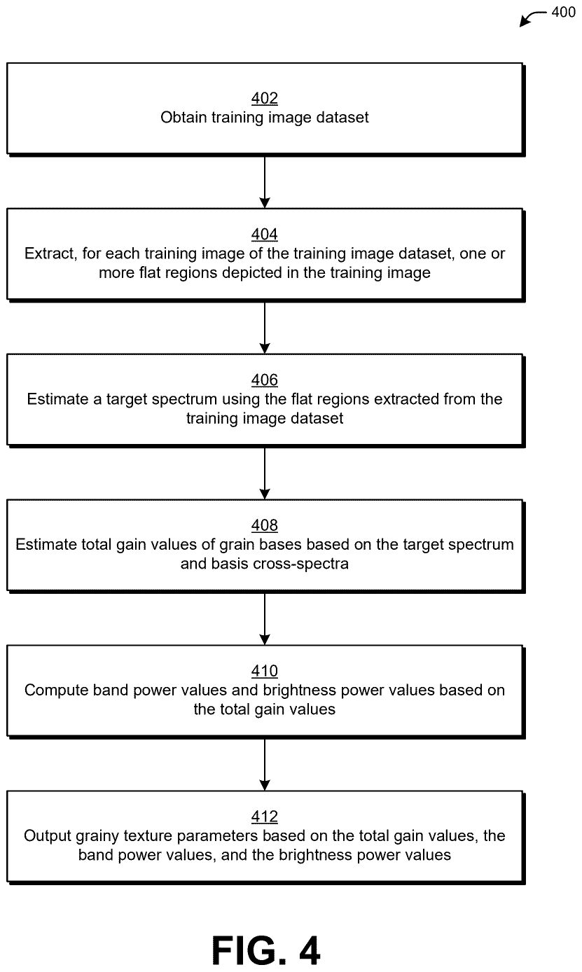

FIG. 4 depicts a procedure 400 in an example implementation of generating grainy texture parameters learned from a training image dataset in accordance with the techniques described herein.

To begin, a training image dataset is obtained (block 402). The grainy texture system 124, for instance, receives training image dataset 202. In some implementations, the training image dataset 202 is obtained from system memory 106. Alternatively or additionally, the training image dataset 202 is received from a data storage location remote from a processing system 100 implementing the grainy texture system 124 (e.g., one or more different processing systems or computing devices communicatively coupled to the processing system 100 implementing the grainy texture system 124).

For each training image in the training image dataset, one or more flat regions are extracted from the training image (block 404). The extraction circuitry 204 of the grainy texture system 124, for instance, extracts one or more flat regions 206 from each image in the training image dataset 202. In one implementation, for instance, the extraction circuitry 204 extracts the one or more flat regions 206 based on manual labeling identifying flat regions 206. Alternatively or additionally, the extraction circuitry identifies flat regions 206 using known edge detection techniques. Alternatively or additionally, the extraction circuitry 204 extracts the one or more flat regions 206 by leveraging deep learning methods (e.g., convolutional neural networks) to perform semantic segmentation.

A target spectrum is then estimated using the flat regions extracted from the training dataset (block 406). The spectral analysis circuitry 208, for instance, estimates a target spectrum 210 based on the one or more flat regions 206 extracted from each training image in the training image dataset 202.

Total gain values of gain bases are then estimated based on the target spectrum and the basis cross-spectra (block 408). The grainy texture circuitry 212, for instance, receives the target spectrum 210 from the spectral analysis circuitry 208 and receives basis cross-spectra 214. In some implementations the basis cross-spectra 214 are obtained from system memory 106. Alternatively or additionally, the basis cross-spectra 214 are received from a data storage location remote from a processing system 100 implementing the grainy texture system 124 (e.g., one or more different processing systems or computing devices communicatively coupled to the processing system 100 implementing the grainy texture system 124). Using the target spectrum 210 and the basis cross-spectra 214, the grainy texture circuitry 212 generates grain bases gain values 216.

At least one band power value and at least one brightness power value are computed based on the grain bases gain values (block 410). The power circuitry 218, for instance, generates band power 220 based on the grain bases gain values 216. The circuitry 222, for instance, generates the brightness power 224 based on the grain bases gain values 216.

Grainy texture parameters are then output based on the total gain values, the band power value(s), and the brightness power value(s) (block 412). The grainy texture system 124, for instance, generates the grainy texture parameters 226 based on the grain bases gain values 216, and specifically the band power 220 and the brightness power 224 derived from the grain bases gain values 216 (e.g., for use by the image processing system 126).

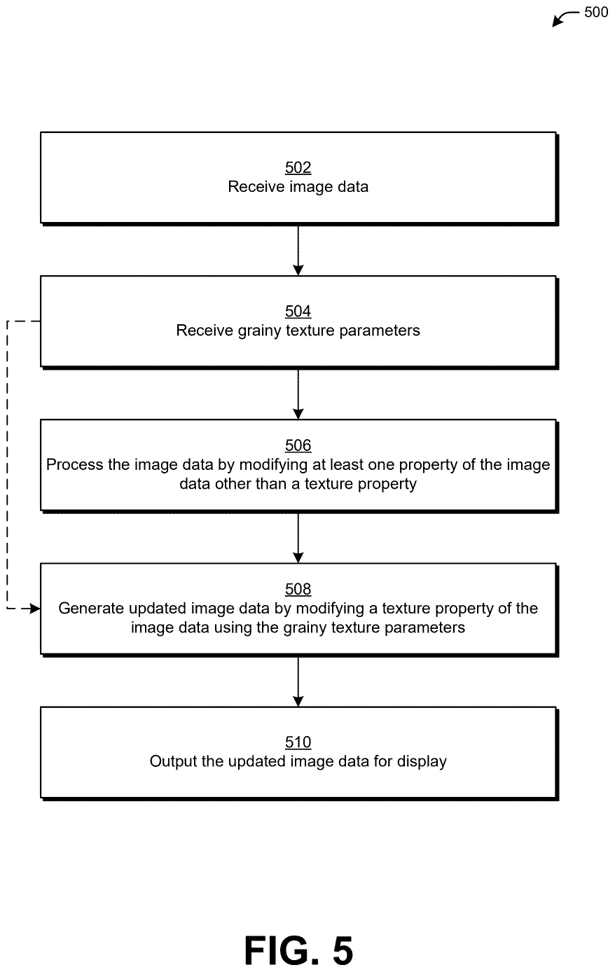

FIG. 5 depicts a procedure 500 in an example implementation of updating image data by modifying a texture property of the image data using grainy texture parameters generated in accordance with the techniques described herein.

To begin, image data is received (block 502). The image processing system 126, for instance, receives image data 302 captured by image sensor 154. In some implementations, the image sensor 154 is implemented on a same device as a device implementing the image processing system 126. Alternatively, in some implementations the image sensor 154 and the image processing system 126 are implemented on different computing devices (e.g., different processing systems).

Grainy texture parameters are also received (block 504). The image processing system 126, for instance, receives grainy texture parameters 226 generated by the grainy texture system 124.

At least one property of the image data, other than a texture property, is optionally processed (block 506). The image processing system 126, for instance, implements non-texture circuitry 304 to process at least one property of the image data 302 other than a texture property (e.g., using one or more of the white balance circuitry 306, the demosaicking circuitry 308, the gamma correction circuitry 310, the edge enhancement circuitry 312, and so forth). This optional performance of processing a non-texture property of the image data 302 is represented by the dashed arrow circumventing block 506.

Updated image data is generated by modifying a texture property of the image data using the grainy texture parameters (block 508). The image processing system 126, for instance, modifies grainy texture visual characteristics of the image data 302 by balancing the visual appearance of “grain” with image brightness power and band power, as quantified by the band power 220 and brightness power 224. By adjusting band power values of image data 302, the image processing system 126 controls the granularity of the image texture resulting in grainy texture image 316. For example, increasing high-frequency band power amplifies finer details and creates a more granular appearance. Conversely, reducing high-frequency band power smooths the texture. Simultaneously, brightness power adjustments influence the perception of graininess, as higher brightness levels reduce the contrast between textured and non-textured areas, making the grain appear softer. By carefully tuning both the brightness and band power values, the image processing system 126 creates a texture that appears more subtle or intense, depending on the desired effect as represented by the training image dataset 202.

The updated image data is then output for display (block 510). The image processing system 126, for instance, outputs the grainy texture image 316. In some implementations, the grainy texture image 316 is output for display (e.g., via the display 130 of processing system 100). Alternatively or additionally, the grainy texture image 316 is output for storage (e.g., in system memory 106 of the processing system 100, via a computing device communicatively coupled to the processing system 100, combinations thereof, and so forth).

Various implementations are possible based on the disclosure herein, and the described techniques are not so limited to the specific examples described above. Although features and elements are described above in particular combinations, each feature or element is usable alone without the other features and elements or in various combinations with or without other features and elements.

What is claimed is:

1. An apparatus comprising:
a processor to generate grainy texture parameters based on grainy texture depicted in images of a training image dataset; and
memory to store a grainy texture image generated by modifying image data using the grainy texture parameters.

2. The apparatus of claim 1, wherein the processor is configured to generate the grainy texture parameters by analyzing the grainy texture depicted in the images of the training image dataset in a frequency domain.

3. The apparatus of claim 1, wherein the processor is configured to generate the grainy texture parameters by extracting at least one flat region from each of the images included in the training image dataset.

4. The apparatus of claim 3, wherein the processor is configured to generate the grainy texture parameters by estimating a target spectrum, based on the at least one flat region.

5. The apparatus of claim 4, wherein the processor is configured to generate the grainy texture parameters by generating grain bases gain values based on the target spectrum.

6. The apparatus of claim 5, wherein the grain bases gain values comprise gain values for a plurality of different grain bases, wherein the plurality of different grain bases comprise at least a coarse grain, a medium grain, and a fine grain.

7. The apparatus of claim 5, wherein the processor is further configured to generate the grain bases gain values based on basis cross-spectra that represent a comparison of frequency domain characteristics of two grainy texture bases.

8. The apparatus of claim 5, wherein the processor is configured to generate the grainy texture parameters by deriving at least one band power value from the grain bases gain values.

9. The apparatus of claim 5, wherein the processor is configured to generate the grainy texture parameters by deriving at least one brightness power value from the grain bases gain values.

10. The apparatus of claim 1, wherein the processor is further configured to generate the grainy texture image by modifying at least one non-texture parameter of the image data.

11. The apparatus of claim 1, further comprising a display configured to output a visual representation of the grainy texture image.

12. A system comprising:
connection circuitry configured to receive a training image dataset comprising a plurality of images; and
grainy texture circuitry configured to:
extract one or more flat regions from each of the plurality of images included in the training image dataset;
estimate a target spectrum based on the one or more flat regions;
generate gain values for at least two grain bases based on the target spectrum;
generate at least one band power value based on the gain values for the at least two grain bases;
generate at least one brightness power value based on the gain values for the at least two grain bases; and
output grainy texture parameters that include the at least one band power value and the at least one brightness power value.

13. The system of claim 12, wherein the grainy texture circuitry is further configured to generate gain values for the at least two grain bases based on basis cross-spectra that represent a comparison of frequency domain characteristics of two grainy texture bases.

14. The system of claim 12, wherein the at least two grain bases include at least a coarse grain, a medium grain, and a fine grain.

15. The system of claim 12, further comprising image processing circuitry configured to generate a grainy texture image by modifying image data using the grainy texture parameters.

16. The system of claim 12, wherein the grainy texture circuitry is configured to extract the one or more flat regions from each of the plurality of images included in the training image dataset before transforming each of the plurality of images included in the training image dataset from a spatial domain to a frequency domain.

17. A method implemented by at least one processing device, the method comprising:
receiving a training image dataset that includes a plurality of training images;
generating grainy texture parameters that represent, in a frequency domain, grainy texture as depicted in the plurality of training images of the training image dataset;
generating a grainy texture image by modifying image data using the grainy texture parameters; and
displaying the grainy texture image.

18. The method of claim 17, wherein generating the grainy texture parameters comprises:
extracting at least one flat region from each of the plurality of training images of the training image dataset;
estimating a target spectrum based on the at least one flat region;
generating grain bases gain values based on the target spectrum;
deriving at least one band power value from the grain bases gain values; and
deriving at least one brightness power value from the grain bases gain values.

19. The method of claim 18, wherein the grain bases gain values comprise gain values for a plurality of different grain bases, wherein the plurality of different grain bases comprise at least a coarse grain, a medium grain, and a fine grain.

20. The method of claim 17, further comprising generating the grainy texture image by modifying at least one non-texture parameter of the image data independent of the grainy texture parameters.
